(19) United States
(12) Patent Application Publication
(10) Pub. No.: US 2022/0203611 A1
(43) Pub. Date: Jun. 30, 2022

(54) ADDITIVE MANUFACTURING OF A FLAT TEXTILE PRODUCT

(71) Applicant: ON CLOUDS GMBH, CH-8005 ZÜRICH (CH)

(72) Inventors: Olivier Bernhard, Heiden (CH); Ilmarin HEITZ, Zürich (CH); Nils ALTROGGE, Zumikon (CH); Kristina SHEA, Zürich (CH); Tim CHEN, Zürich (CH); Jonas SCHWARZ, Zürich (CH)

(73) Assignee: ON CLOUDS GMBH, CH-8005 ZÜRICH (CH)

(21) Appl. No.: 17/605,928

(22) PCT Filed: Apr. 6, 2020
(86) PCT No.: PCT/EP2020/059812

§ 371 Date: Oct. 22, 2021

(30) Foreign Application Priority Data
Apr. 26, 2019 (CH) 00560/19

(51) Int. Cl. B29C 64/194; B33Y 10/00; B33Y 80/00; D04B 39/00; D03D 25/00; B33Y 40/20; D04B 39/06; B29C 71/00

(52) U.S. Cl. CPC B29C 64/194; B33Y 10/00; B33Y 80/00; B29C 71/00; D03D 25/005; B33Y 40/20; D04B 39/06; D04B 39/00

(57) ABSTRACT

A method for additively manufacturing a textile sheet product and a three-dimensionally printed textile sheet product (1) are disclosed. The method includes the steps of creating a three-dimensional model of the pre-product and additively manufacturing the pre-product according to the three-dimensional model of the pre-product. In additive manufacturing, a production material is applied layer by layer in this case. At at least one predetermined crossover position of at least two fibrous structures (2a, 2b) and a separation layer material is applied which can be removed from the pre-product and/or inactivated.

### BACKGROUND OF THE INVENTION

### Field of the Invention

The invention relates to a method for additively manufacturing a textile sheet product, and to a three-dimensionally printed textile sheet product.

### Discussion of Related Art

Textile flat products are products containing fibers, which are processed into flat structures by a wide variety of conventional methods. The most common manufacturing processes for flat textile products are weaving, warp knitting and knotting. In most cases, threads and/or yarns serve as the starting material for the manufacture of a textile sheet product. These are then joined together by means of one of the above-mentioned processes.

For example, in weaving, the fibers or threads of two fiber systems, the warp and the weft, which are essentially arranged transversely or even perpendicularly to each other, are crossed to form a fabric. In knitting, on the other hand, the fibers are joined together by looping.

Textile sheet products offer the advantage of being relatively flexible compared to other sheet materials, since the fibers are arranged so as to be movable relative to one another, or can be displaced relative to one another. A woven fabric, which as described above may consist of two fiber systems arranged substantially perpendicular to each other, normally forms a pattern of a plurality of square recesses. Such a fabric is virtually inflexible in the direction of one of the two fiber systems, but exhibits some flexibility at an angle of about 45° to the fiber systems due to the relative mobility of the individual fibers with respect to each other.

Additive manufacturing of workpieces, which is also commonly referred to as 3D printing, offers a fast and cost-effective approach to the production of models, prototypes, tools and end products. Characteristic of additive manufacturing techniques, is that the material is applied or at least formed, layer by layer, thus creating three-dimensional objects.

Various additive manufacturing techniques are known in the state of the art. The most widely used techniques include stereolithography (SLA), laser sintering (SLS), laser beam melting (LBM), polyjet modeling (polyjet or PJM), multi jet modeling (MJM) or fusion deposition (FDM).

### SUMMARY OF THE INVENTION

One disadvantage of the conventional processes described above for manufacturing textile sheet products is that the process is severely limited in terms of manufacturing variability, especially with regard to industrial production. For example, it is not readily possible to manufacture a textile sheet product in which several of the above processes are used. For example, it is not possible to produce a combination of knitted and woven fabric. Furthermore, the fibers also cannot be easily changed during the process. For example, it would be advantageous if the fibers had a different width, diameter, shape, height width and/or material composition at predetermined points.

The flexibility of textile sheet products already mentioned above, for example of a woven or knitted fabric, can be very advantageous and desirable in some cases. However, a flexible, in particular stretchable and/or extensible textile sheet product can also be disadvantageous, as these tend to deform, for example, during prolonged use. Particularly in the case of functional clothing, it may be desirable for a certain flexibility of the fibers to be present at certain points of the garment, while it may be undesirable at other points of the same garment. With the help of common processes, a compromise must be made here in terms of flexibility, or costly alternative solutions must be pursued.

The additive manufacturing of textile sheet products is difficult because the individual fibers of such a product are often very thin and thus the distances between the fibers, for example the so-called mesh size, are very small. For this reason, the individual fibers often stick together during production, which is why fiber crossovers, which are characterized by the fact that the fibers can move freely in relation to each other at the crossovers, still cannot be produced.

It is thus the general object of the invention to further develop the state of the art in the field of three-dimensionally printed textile sheet products and methods for the additive manufacturing of textile sheet products, and advantageously to overcome the disadvantages of the state of the art in whole or in part.

In advantageous embodiments, a method is provided for the additive manufacturing of a textile sheet product, which allows three-dimensionally printed textile sheet products with a plurality of fibrous structures to be provided, wherein at least some of the fibrous structures form crossovers at which the fibrous structures are arranged so as to be movable relative to one another and are preferably not bonded to one another at these crossovers. Structures arranged so as to be movable relative to one another thus do not form fixed connections at the respective crossovers.

In further embodiments, a three-dimensionally printed textile sheet product is provided which has properties, in particular the flexibility, of a conventionally produced woven, knitted or knitted fabric.

The general problem is solved by a method for additively manufacturing a textile sheet product having a plurality of fibrous structures according to a first aspect of the invention. The method according to the invention comprises the steps of: creating a three-dimensional model of the pre-product and additively manufacturing the pre-product according to the three-dimensional model of the pre-product. In additive manufacturing, a production material is applied layer by layer. At at least one predetermined crossover position of at least two fibrous structures, a separation layer material is applied which is removable and/or inactivatable from the pre-product. The skilled person understands that at the beginning of the additive manufacturing, the production material is typically applied to a base, which is usually neither part of the pre-product nor of the textile sheet product. After the additive manufacturing of the pre-product has been completed, it can be removed from such a base.

In typical embodiments, the application of the production material and the separation layer material is sequential, in particular staggered. Thus, the production material and the separation layer material are typically not applied simultaneously.

With a method according to the invention, a local and/or temporary separation of individual fibrous structures in the pre-product can thus be achieved. The separating¬ layer material prevents the layers of the production material from touching each other, at least during additive manufacturing. This is particularly advantageous during additive manufacturing, as it prevents the production material of one fibrous structure, which may still be flowable or soft, from forming a material bond with the production material of another fibrous structure locally at the crossover positions. Since the position of the separation layer material, the crossover position, can be predetermined, it is thus possible to selectively determine at which positions the fibrous structures are to be arranged immovably relative to one another and at which positions they are to be arranged flexibly, i.e., movably relative to one another. Consequently, the method according to the invention can be used to produce a textile fabric with a, in particular in itself, variable flexibility.

A textile sheet product according to the present invention refers to products comprising a plurality of fibrous structures interconnected by crossovers. In some embodiments, the textile sheet product may consist essentially of fibrous structures.

A crossover is generally a connection of at least two fibrous structures, which are, however, not connected to each other by a material bond. In particular, the fibrous structures are freely movable relative to each other at least at one crossover.

The three-dimensional model of the pre-product is typically created on a CAD (computer aided design) basis. The resulting CAD data can then be converted into a format that can be read, in particular, by a 3D printer for subsequent additive manufacturing.

The production material typically refers to the material of which the textile sheet product made by the method of the invention essentially consists. In some embodiments, the production material may comprise, for example, polyester, polyamide, polyimide, aramid, polyacrylic, polyethylene, polypropylene, elastane, nylon, polyurea, polyphenylene sulfide, melamine, or mixtures thereof. It is also possible to use the respective monomer precursors as the production material, such as methyl acrylate to produce a polyacrylic.

The production material and the separation layer material are typically different materials, which in particular have different chemical and/or physical properties.

In some embodiments, a crossover position of at least two fibrous structures is predetermined when creating the three-dimensional model of the pre-product. For example, the crossover position may be predetermined or programmed into CAD data.

In the context of the present invention, a removable separation layer is a layer that is removable or separable without the application of greater mechanical force and/or without destroying/damaging the applied production material, its spatial structure, the pre-product and/or the obtained textile sheet product. Typically, the separation layer may be chemically removable, for example by dissolution. Alternatively, instead of being removable, the separation layer material may be designed to be inactivatable. Thus, cutting out, tearing off, and similar processes do not fall under the term “remove” for purposes of the present invention. For example, it may be possible that the separation layer material can be converted from a first, active state, to a second, inactive state, by the application of energy. This can be achieved, for example, by means of electromagnetic radiation. In the inactive state, the separation layer material can, for example, become unstable, in particular porous, brittle or liquid, so that it can subsequently be removed from the pre-product. For the removal of the separation layer material, the force occurring during running can generally be sufficient.

Typically, the separation layer material at least temporarily prevents at least two fibrous structures from contacting each other at a crossover position, at least during the additive manufacturing of the pre-product, and thereby forming a material bond.

In further embodiments, the separation layer material is removed or alternatively inactivated in a subsequent step, i.e., following additive manufacturing of the pre-product.

In further embodiments, the separation layer material is deposited between two layers of the production material of at least two fibrous structures during additive manufacturing. Typically, this is done at a predetermined crossover position. After removal or inactivation of the separation layer, two intersecting fibrous structures are thus obtained from the production material, which are freely movable relative to one another and are not material bonded to one another at least at the crossover.

Typically, during additive manufacturing of the pre-product, one or more layers of the production material are applied first, then one or more layers of the separation layer material are applied at a predetermined crossover position, and then one or more layers of the production material are applied again. The application of the production material and the separation layer material is therefore preferably carried out sequentially, i.e., in particular not simultaneously. Optionally, this process can be repeated as often as desired in the direction of production, i.e., in the vertical direction.

In further embodiments, the separation layer material comprises a soluble polymer, preferably a photopolymer. For example, a water-soluble polymer can be used as the separation layer material and a water-insoluble production material can be used at the same time. Particularly preferred, however, are separation layer materials which are soluble in alkali or acid. For example, soluble and/or hydrolyzable polyesters or polyamides can be used. These can be removed from the pre-product with comparatively little residue. In addition, alkaline or acidic soluble polymers are often only poorly soluble in neutral aqueous solutions, but very well soluble in basic or acidic solutions. Compared to purely water-soluble polymers, this has the advantage that water does not have to be strictly avoided in additive manufacturing, or its occurrence must be avoided in order to prevent premature and unwanted removal of the separation layer material.

In some embodiments, the separation layer material may be removed by immersion in an aqueous immersion bath, particularly an acidic or alkaline immersion bath.

Photopolymers offer the advantage that they change their properties when exposed to radiation of a certain wavelength, in particular radiation in the UV-VIS range. Thus, a photopolymer can be used which first becomes soluble, in particular water-soluble, or porous and/or brittle when irradiated with light and can thus be very easily removed from the pre-product. The use of photopolymers has the advantage that they can be removed very selectively and very gently for the production material. Thus, a very precise separation between two fibrous structures at the crossover can be achieved without damaging them. As long as the production material is not also a photopolymer, it will essentially not change upon removal of the separation layer material. Alternatively, a photopolymer can be used that liquefies upon exposure to light. For example, various polyesters or polyamides can be used as photopolymers, such as a polymer of acrylic acid 2-hydroxyethyl ester, N,N-dimethylacrylamide, dipentaerythritol pentaacyrlate, N,N-dimethyl-1,3-propylenebisacrylamide, or a copolymer of an acrylic acid derivative, such as acrylic acid 2-hydroxyethyl ester, and an alcohol.

Alternatively, a powder or even a gel can be used as the separation layer material, which can be removed and/or inactivated.

In further embodiments, the separation layer material is removed by washing. Washing out in an alkaline bath has proved to be particularly effective in this respect, since this has resulted in textile fabrics in which the individual fibrous structures separated by the separation layer showed essentially no cohesive bonds and in which the separation layer material could quickly be completely removed. For example, such an alkaline bath may include an aqueous solution of sodium hydroxide and optionally sodium silicate. Depending on the separation layer material, washing out can also be achieved with an acidic solution.

In further embodiments, the textile sheet product comprises a woven fabric, knitted fabric and/or warp knitted fabric. The skilled person understands that this term does not refer to the manufacturing method, since the textile sheet product is not manufactured by conventional textile processes such as weaving, knitting, knotting or warp knitting, but to the fact that the product obtained by additive manufacturing has at least partially the properties, in particular the fiber structure or fiber course, of a woven fabric, knitted fabric or warp knitted fabric.

For example, it can be determined during the creation of the three-dimensional pre-product that the textile sheet product is to comprise a woven. In this case, the predetermined crossover positions are selected in such a way that, after removal of the separating layer material, the structure and/or fiber course of a woven fabric is formed. Compared to conventional weaving, the method according to the invention has the advantage that different textile structures can be obtained in different areas within the textile sheet product. For example, one area of the textile sheet product can be formed as a woven fabric and another as a knitted fabric.

In a method according to the invention, the textile structure with fibrous structures being movable with respect to each other, in particular the crossovers, is not achieved by conventional methods, in particular mechanical methods, such as knitting, weaving or warp knitting, but directly by additive manufacturing and preferably by removing the separation layer material.

According to further embodiments, connection points of the pre-product are defined during the creation of the model of the three-dimensional pre-product, wherein the connection points remain free of separation layer material during the subsequent additive manufacturing and/or crossover positions are defined, wherein the crossover positions are coated with separation layer material during the subsequent additive manufacturing. Such embodiments have the advantage that areas or directions of the manufactured textile sheet product can be determined which are flexible, for example stretchable, and other areas or directions which are designed to be inflexible and thus not flexible. For example, a woven fabric can be produced as the basic textile structure, but this fabric has connection points at which two fibrous structures are connected to one another in a material locking manner. Additionally, or alternatively, however, such a woven fabric may have crossover points or may have crossover points only, such that the fibrous structures are not bonded to each other at substantially any position. However, the method according to the invention has the advantage that it can be precisely predetermined in which areas and/or in which directions the textile sheet product is to be designed to be rather stiff and inflexible and in which areas and/or directions it is to be designed to be flexible.

For example, connection points can be used to limit the flexibility within the textile sheet product along a line or strip that can be predetermined. If, for example, a continuous line of connection points is defined in the three-dimensional model of the pre-product, then no separation layer material is applied there during additive manufacturing, so that the corresponding fibrous structures join together in a material bond at this point.

In further embodiments, the separation layer material can be applied in a thickness of 0.01 to 0.3 mm, preferably 0.05 to 1.5 mm. It has been shown that this thickness results in the at least two fibrous structures being spaced sufficiently far apart from one another at the crossovers during additive manufacturing, so that no material bond can form between these structures.

In further embodiments, the additive manufacturing is carried out with a layer thickness of 0.01 to 0.1 mm, preferably 0.01 to 0.04 mm. This achieves a resolution that is satisfactory for appropriate use as a textile sheet product, for example as clothing, such as pants, T-shirts or shoes.

Preferably, additive manufacturing is carried out by means of selective laser sintering (SLS), laser-based stereolithography (SLA), polyjet or fusion deposition (FDM). However, other, in particular variations of the additive manufacturing methods described above are also possible.

According to a further aspect of the invention, the technical object is solved in a general manner by a three-dimensionally printed textile sheet product according to the invention. The three-dimensionally printed textile sheet product according to the invention comprises fibrous structures which are connected to one another by crossovers and are arranged so as to be at least partially movable relative to one another.

In some embodiments, the three-dimensionally printed textile sheet product may consist essentially of the fibrous structures.

The skilled person understands that a three-dimensionally printed product has a layered structure. As disclosed above, additive manufacturing can be carried out, for example, with a layer thickness of 0.01 to 0.1 mm, preferably 0.01 to 0.04 mm. Generally, in a layered structure, the polymer chains of the production material are directed horizontally, i.e., in the layer plane. In addition, the layer thickness defines layer portions which are arranged one above the other in the vertical direction. The layered structure can also be visible from the outside or made visible by means of imaging processes.

In addition, the fibrous structures may merge and/or be joined together at the ends.

A three-dimensionally printed textile sheet product can be produced according to one of the embodiments of a method according to the invention described above.

As already explained, at least two fibrous structures are arranged at the crossovers so as to be movable relative to one another, i.e., these are not joined at the crossovers, in particular by a material bond.

In some embodiments, the crossovers include knotting, interlacing, weaving, and/or looping, respectively interlinking. It is also possible, in further embodiments, for a textile sheet product to include a plurality of different crossovers. For example, a textile may have only interlacing in a certain area and only interweaving in another area. In this way, specific areas of the textile sheet product or of a garment made therefrom can be customized without delaying and/or increasing the cost of manufacture.

In further embodiments, the individual fibrous structures have in themselves a variable thickness, a variable diameter, a variable height and/or width, and/or a variable cross-sectional shape. For example, it is possible for the cross-section of a fibrous structure to be round at one location of the sheet product, and for the cross-section of the same fibrous structure to be angular and/or flat at another location. Furthermore, individual fibrous structures may have thickenings at predetermined locations, for example spherical thickenings, which may restrict movement relative to another fibrous structure of the textile sheet product, in particular by entanglement. A variable thickness or diameter of the individual fibrous structures can be used, for example, to reinforce or protect particularly stressed areas of a garment made from the textile sheet product. For example, wrinkles in the upper of a shoe often occur at the same position when walking, making them susceptible to breakage of the fibrous structures at that position. Increasing the diameter in this area can thus prevent such breakage. Reducing the thickness of the fibrous structures can be advantageous if, for example, a garment is to be designed to be particularly breathable and/or particularly flexible at one point.

In other embodiments, the fibrous structures are not bonded together at the crossovers.

In further embodiments, the textile sheet product comprises a woven fabric with a first and a second fiber system. The fibrous structures of the first and the second fiber system cross each other transversely, in particular perpendicularly to each other. The skilled person understands that a fiber system comprises a plurality of fibrous structures which are arranged substantially parallel to each other within the fiber system. Such a textile sheet product has the advantage that it can be designed to be similar to or equally flexible as a conventional fabric produced by textile weaving. Such a sheet product can be designed to be inflexible, i.e., not stretchable or extendable, in the direction of both fiber systems and to be flexible, i.e., extendable or stretchable, in at least two further directions.

In further embodiments, a textile sheet product comprising a first fiber system and a second fiber system comprising a woven fabric includes a third fiber system. The fibrous structures are crossed with the fibrous structures of the first and second fiber systems. Typically, the third fiber system is not arranged in parallel with either the first or second fiber systems in this regard. It is possible, for example, that the third fiber system is arranged at an angle of 40° to 50°, preferably substantially 45°, to both the first and second fiber systems. Such a textile sheet product has the advantage that it can be designed to be inflexible, inflexible and/or rigid in three horizontal directions, namely in all three directions of the respective fiber systems, while it can be designed to be flexible in a further, fourth direction.

In other embodiments, the textile sheet product comprises a woven fabric having a first, second and third fiber system as described above and additionally a fourth fiber system. This is typically not arranged parallel to the first, second and/or third fiber system. For example, the fourth fiber system may be arranged transversely, preferably perpendicularly, to the third fiber system. Thus, a fabric is obtained which is inflexible, i.e., rigid, in all four directions of the individual fiber systems.

Another aspect of the invention relates to a garment comprising a three-dimensionally printed textile sheet product according to the above disclosure. In particular, the garment may be selected from the fields of functional clothing, such as motorcycle clothing, sports clothing and fire protection clothing. Typically, the term garment includes outerwear such as T-shirts, jackets, undergarments, and pants, as well as footwear or hosiery, particularly athletic footwear.

Another aspect of the invention relates to the use of a three-dimensionally printed textile sheet product according to the above disclosure to produce a garment.

### BRIEF DESCRIPTION OF SEVERAL VIEWS OF THE DRAWINGS

Aspects of the invention are explained in more detail with reference to the embodiments shown in the following figures and the accompanying description.

FIG. 1 shows a section of a three-dimensionally printed textile sheet product according to one embodiment of the invention;

FIG. 2 shows a schematic view of a three-dimensionally printed textile sheet product according to a further embodiment of the invention;

FIG. 3 shows a schematic view of a three-dimensionally printed textile sheet product according to a further embodiment of the invention;

FIG. 4 shows a schematic view of a three-dimensionally printed textile sheet product according to a further embodiment of the invention;

FIG. 5 shows a section of a three-dimensionally printed textile sheet product according to a further embodiment of the invention;

FIG. 6 shows a detail enlargement of a three-dimensionally printed textile sheet product according to a further embodiment of the invention;

FIG. 7a schematically shows an additively manufactured pre-product in cross-section according to one embodiment of the invention; and

FIG. 7b shows a schematic cross-section of the three-dimensionally printed textile sheet product of FIG. 1.

### DETAILED DESCRIPTION OF THE INVENTION

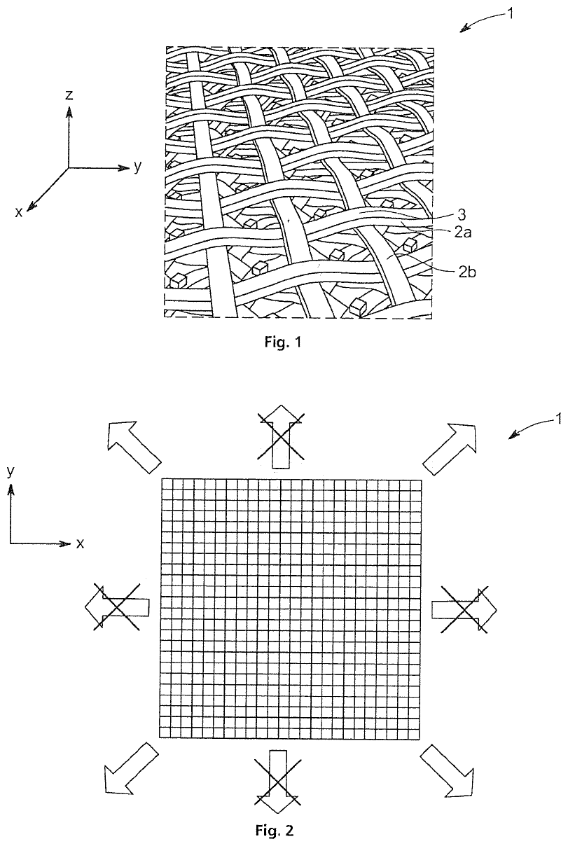

FIG. 1 shows a three-dimensionally printed textile sheet product 1 according to the invention, which was manufactured additively according to a method according to the invention. The textile sheet product 1 extends in the horizontal plane of the x and y direction, as shown by the coordinate system. Additive manufacturing is performed layer by layer in the vertical direction, i.e., along the z-axis in the coordinate system shown. The three-dimensionally printed textile sheet product 1 contains fibrous structures 2a and 2b, which are interconnected by crossovers 3. In the embodiment shown, the crossovers are formed as interweavings. The fibrous structures 2a and 2b have a substantially rectangular cross-section. As shown in the figures below, the fibrous structures are arranged to be movable relative to each other.

FIG. 2 shows a schematic representation of a three-dimensionally printed textile sheet product 1 according to an embodiment of the invention. The textile sheet product 1 contains fibrous structures which are interconnected by weaving. The woven fabric thereby comprises a first fiber system which extends in the y-direction. As shown, the first fiber system comprises a plurality of parallel fiber-like structures extending in the y-direction. The woven fabric further comprises a second fiber system extending in the x-direction of the coordinate system shown. The second fiber system thereby comprises a plurality of fibrous structures being parallel to each other and extending in the x-direction. As indicated by the arrows, such a three-dimensionally printed textile sheet product 1 has the advantage that it is not flexible in either the x or y direction, but is flexible in each case at an angle of 45° to the x or y direction. Thus, the textile fabric 1 cannot be stretched in the direction of the crossed-out arrows, but it can be stretched in the direction of the four diagonal arrows shown. This can be advantageous, for example, in the case of garments which are stretched in certain directions but are to be as rigid as possible in other directions in order, for example, to support and thus facilitate and/or guide a movement of the wearer. If this is desired, during the manufacture of a three-dimensional surface product, instead of some crossover positions, connection points can be determined at which no separation layer material is applied. In the subsequent additive manufacturing process, these connection points become materially bonded joints of the respective intersecting fibrous structures. Thus, the achieved flexibility can be interrupted at predetermined areas. For example, in this or further embodiments described herein, a flexibility separation line can be provided, which is predetermined by corresponding arrangement of connection points in the three-dimensional model during manufacture.

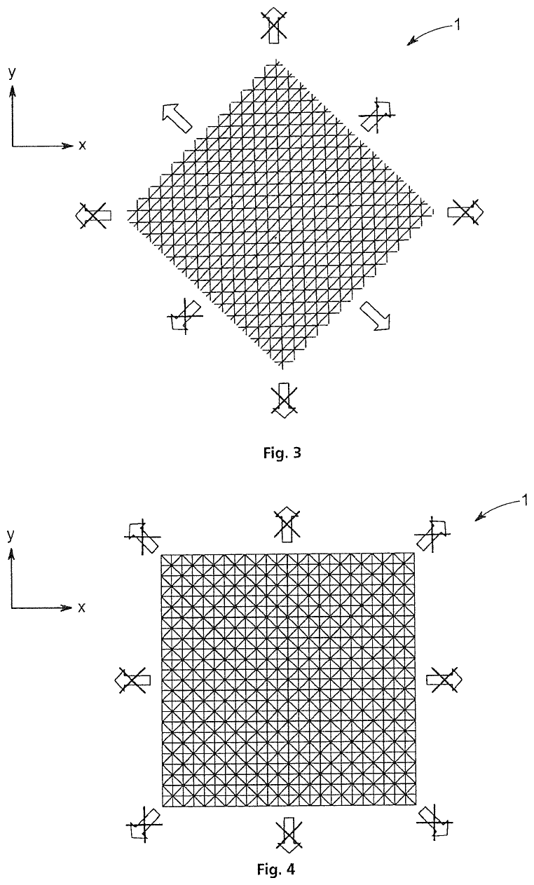

FIG. 3 shows a schematic representation of a three-dimensionally printed textile sheet product 1 according to a further embodiment of the invention. The textile sheet product 1 also comprises a woven fabric with a first and a second fiber system (see FIG. 2). In addition, the three-dimensionally printed textile sheet product 1 shown has a further, third fiber system. The third fiber system comprises a plurality of fibrous structures arranged parallel to each other, which are each arranged at an angle of substantially 45° to the fiber-shaped structures of the first and second fiber systems. The fiber-shaped structures of the three fiber systems are thereby connected to each other in each case by crossovers. As indicated by the shown crossed-out arrows, the third fiber system has the consequence that the textile sheet product 1 is neither flexible in x direction, nor in y direction, and additionally not flexible in a further third direction arranged at substantially 45° to the x and y direction. However, the textile sheet product 1 is arranged to be flexible, respectively stretchable and/or extensible, in one direction, namely as represented by the two diagonal arrows. In the present coordinate system, this direction is described by a straight line of the function y=−x.

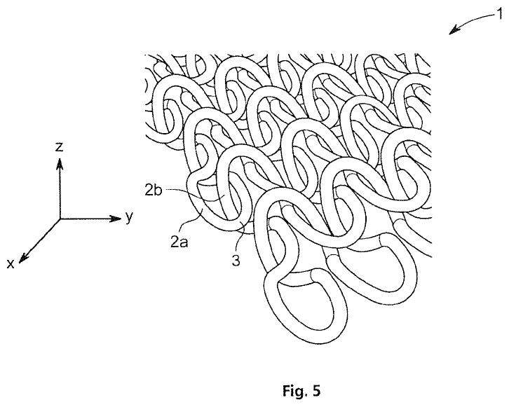

FIG. 4 schematically shows a further embodiment of a three-dimensionally printed textile sheet product 1 according to the invention. The textile sheet product 1 comprises a woven fabric with a first, second and third fiber system, as already shown in FIG. 3. In addition, the textile sheet product further comprises a fourth fiber system with mutually parallel fibrous structures arranged 90° to the third fiber system and 45° to the first and second fiber systems. Compared with the textile fabric of FIG. 3, such a woven fabric is essentially inflexible in all directions, since the fourth fiber system prevents stretching and/or elongation in the direction y=−x. Such an area product can also be achieved by superimposing two three-dimensionally printed textile area products rotated by 45° relative to each other, as shown in FIG. 2.

FIG. 5 shows a three-dimensionally printed textile sheet product 1 according to the invention, which can be manufactured additively by a method according to the invention. The textile sheet product 1 extends in the horizontal plane of the x- and y-directions, as shown by the coordinate system. Additive manufacturing is performed layer by layer in the vertical direction, i.e., along the z-axis in the coordinate system shown. The three-dimensionally printed textile sheet product 1 contains fibrous structures 2a and 2b, which are interconnected by crossovers 3. In the embodiment shown, the crossovers are formed as interlaces, so that the three-dimensionally printed textile sheet product 1 comprises a knitted fabric, or a warp-knitted fabric.

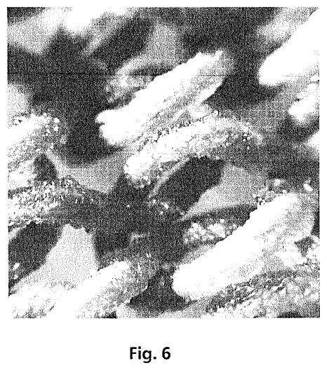

FIG. 6 shows a photograph of a knitted fabric after removal of the separation layer material. It can be seen that the fibrous structures are not bonded to each other, particularly at the crossovers.

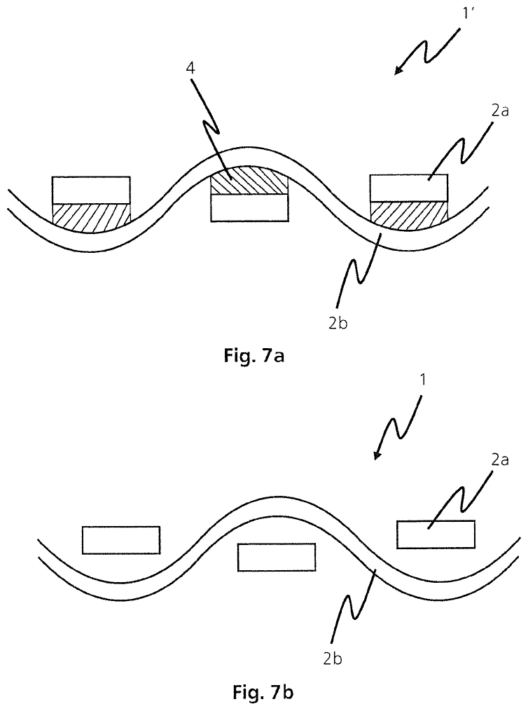

FIG. 7a shows a cross-section of an additively manufactured pre-product 1′ comprising fibrous structures 2a and 2b, wherein a separation layer material 4 is arranged between the structures at the three crossover positions of the fibrous structures 2a and 2b shown. The separation layer material 4 thereby prevents the fibrous structures 2a and 2b of the pre-product 1′ from contacting each other at the crossover positions.

In FIG. 7b, the three-dimensionally printed textile sheet product 1 of FIG. 1 is shown in cross-section along the y-z plane. The textile sheet product can be produced by removing the separation layer material 4 shown in FIG. 7a from the pre-product 1′. The fibrous structures 2a and 2b of the three-dimensionally printed textile sheet product 1 are arranged so as to be movable relative to one another and are not bonded to one another, at least at the crossovers.

1. A method for additively manufacturing a textile sheet product having a plurality of fibrous structures, comprising the steps of:
creating a three-dimensional model of a pre-product;
additive manufacturing of the pre-product according to the three-dimensional model of the pre-product;
applying, during additive manufacturing, a production material layer by layer and a separation layer material at at least one predetermined crossover position of at least two fibrous structures, wherein the separation layer material is removable and/or inactivatable from the pre-product.

2. The method of claim 1, wherein the separation layer material is removed from the pre-product in a subsequent step.

3. The method of claim 1, wherein the separation layer material is deposited between two layers of the production material during additive manufacturing.

4. The method of claim 1, wherein the separation layer material comprises a soluble polymer, preferably a photopolymer, a powder or a gel.

5. The method according to claim 1, wherein the separation layer material is removed from the pre-product by washing with an alkaline solution.

6. The method according to claim 1, wherein the textile sheet product comprises a woven fabric, knitted fabric and/or warp knitted fabric.

7. The method according to claim 1 further comprising the following steps during the step of creating the three-dimensional model of the pre-product:
defining connection points of the pre-product, wherein the connection points remain free of separation layer material during subsequent additive manufacturing; and/or
defining crossover positions, wherein the crossover positions are coated with separation layer material during the subsequent additive manufacturing.

8. The method according to claim 1, wherein the separation layer material is applied in a thickness of 0.01 to 0.3 mm, preferably 0.05 to 1.5 mm.

9. The method according to claim 1, wherein the additive manufacturing is performed with a layer thickness of 0.01 to 0.1 mm, preferably 0.01 to 0.04 mm.

10. The method of claim 1, wherein the additive manufacturing is performed by selective laser sintering (SLS), laser-based stereolithography (SLA), polyjet, or fusion deposition (FDM).

11. A three-dimensionally printed textile sheet product (1), the sheet product (1) containing fibrous structures (2a, 2b) which are connected to one another by crossovers (3), and wherein the fibrous structures (2a, 2b) are arranged such that they can move relative to one another.

12. The three-dimensionally printed textile sheet product (1) according to claim 11, wherein the crossovers (3) comprise knots, interlaces, weavings, and/or loops.

13. The three-dimensionally printed textile sheet product (1) according to claim 11, wherein the individual fibrous structures (2a, 2b) have in themselves a variable thickness, variable diameter, variable height and/or width and/or a variable cross-sectional shape.

14. The three-dimensionally printed textile sheet product (1) according to claim 11, wherein the fibrous structures (2a, 2b) are not material bonded to one another at the crossovers (3).

15. The three-dimensionally printed textile sheet product (1) according to claim 11, wherein the sheet product (1) comprises a fabric having a first and a second fiber system, wherein the fibrous structures of the first and the second fiber system cross each other transversely.

16. The three-dimensionally printed textile sheet product (1) of claim 15, wherein the fabric comprises a third fiber system, wherein the fibrous structures of the third fiber system intersect with the fibrous structures of the first and second fiber systems.

17. A garment comprising a three-dimensionally printed textile sheet product (1) according to claim 11.

18. Use of a three-dimensionally printed textile sheet product according to claim 11 for the manufacture of a garment.
